(19) United States
(12) Patent Application Publication
(10) Pub. No.: US 2018/0366889 A1
(43) Pub. Date: Dec. 20, 2018

(54) CHARGING CONNECTOR

(71) Applicant: HORIZON CO., LTD., Kitaazumi-gun, Nagano (JP)

(72) Inventors: Kiyotaka IMAI, Kitaazumi-gun, Nagano (JP); Yasuhiro IMAI, Kitaazumi-gun, Nagano (JP); Sergii LEONTIEV, Kitaazumi-gun, Nagano (JP)

(21) Appl. No.: 15/564,886

(22) PCT Filed: Aug. 18, 2016
(86) PCT No.: PCT/JP2016/074154

§ 371 Date: Oct. 6, 2017

(30) Foreign Application Priority Data
Feb. 26, 2016 (JP) 2016-000884

(51) Int. Cl. H01R 24/60; H01R 13/642; H01R 13/405; H01R 13/502; H01R 4/02

(52) U.S. Cl. CPC H01R 24/60; H01R 13/642; H01R 2107/00; H01R 13/502; H01R 4/023; H01R 13/405

(57) ABSTRACT

A charging connector comprising, a pair of power supply terminals for pinching power supply terminals of a Type-C plug connector complying with the USB connector standard from both sides, and a pair of grounding terminals and for pinching grounding terminals of the plug connector from both sides, wherein the power supply terminals and the grounding terminals are configured by fork terminals

### CROSS REFERENCE TO RELATED APPLICATIONS

This is a U.S. national stage of application No. PCT/JP2016/074154, filed on Aug. 18, 2016. Priority under 35 U.S.C. § 119(a) and 35 U.S.C. § 365(b) is claimed from Japanese utility model application for registration No. 2016-000884 filed on Feb. 26, 2016, the disclosure of which is also incorporated herein by reference.

### TECHNICAL FIELD

The present invention relates to a charging connector.

### BACKGROUND ART

As a new connector standard, “USB Type C” has been regulated as a future generation standard of USB (Universal Serial Bus). According to the “USB Type C” standard, a connector can supply power to apparatus connected thereto (see for example PTL 1) as a conventional USB connector can.

A conventional USB can supply the power of 5V, 1.5 A and 7.5 W in maximum while a Type-C connector can supply the power of 20V, 5 A and 100 W in maximum in maximum permissive increase in temperature of 30 deg. C.

Since a Type-C connector is required that twenty four terminals should be arranged in a space similar to that of a conventional micro USB connector with five terminals, it is highly integrated. In a Type-C connector, since terminals are inevitably made compact, each of a power supply circuit and a ground circuit can distribute electricity to four terminals as a common circuit.

### CITATION LIST

### Patent Literature

{PTL 1} JP 2002-191133 A

### SUMMARY OF INVENTION

### Technical Problem

In a Type-C connector, when each of a power supply circuit and a ground circuit distributes electric current to four terminals in a common circuit as described above, current passing through each terminal becomes fourth, that is, 1.25 A on each terminal at maximum current 5 A being supplied. In a known Type-C connector, since a common circuit is formed on a printed circuit board to have a small current capacity, it is likely to increase in temperature on power distribution.

Further, in a Type-C connector, terminal members are more compact than those of a conventional USB connector as described above and a stopper mechanism for attaching a plug connector to a jack connector is provided on the jack connector. Therefore, a Type-C connector must have a complex configuration so that it is difficult to lower the manufacturing cost.

A low-priced conventional USB connector, for example, is commercially available with reducing the number of terminals at a jack connector to provide a charging function only for an apparatus connected to be charged. On the other hand, since a Type-C connector requires a high accuracy process for arranging small terminal members on a circuit board, it is difficult to lower the manufacturing cost for such a Type-C connector even though the number of terminals are reduced for charging only. Further, since a Type-C connector requires a stopper mechanism on a jack connector even for charging, it is difficult to product a low-priced one with a charging function only.

The present invention is achieved under such a background to make a Type-C jack connector with a charging function only have a margin in current capacity and to provide a charging connector which can be produced in a low manufacturing cost.

### Solution to Problem

A charging connector according to this invention comprised: a pair of power supply terminals for pinching power supply terminals of a Type-C plug connector complying with the USB connector standard from both sides, and a pair of grounding terminals and for pinching grounding terminals of the plug connector from both sides, for providing a charging function only; wherein the power supply terminals and the grounding terminals are configured by fork terminals.

In the charging connector described above, the fork terminals may be provided with cooling plates.

In the charging connector described above, a pair of the fork terminals may be connected by a cooling plate.

In the charging connector described above, each of the fork terminals may have larger volume than that of a Type-C standard terminal for pinching a power supply terminal or a grounding terminal of a plug connector from both sides.

In the charging connector described above, a soldering terminal may be provided on the cooling plate at opposite side of the fork terminal.

The charging connector described above may further comprise a base part the fork terminals assembled, and a reinforcing shell covering the base part; wherein stopper members complying with a stopper mechanism specified in the Type-C standard are assembled on both sides of the fork terminals in the base part.

In the charging connector described above, the stopper members may be provided with cutout portions respectively at externally extending portions from the base part for gripping a circuit board the charging connector to be connected.

In the charging connector described above, the base part may be provided with a insertion port for a plug connector specified in the Type-C standard, the opening area of the insertion port being smaller than that specified in the Type-C standard.

In the charging connector described above, the base part may comprise insulation members covering the power supply terminals and the grounding terminals partly, the length of parts of the grounding terminals not covered by the insulator members being different from the length of parts of the power supply terminals not covered by the insulator members.

The charging connector described above may further comprise a base part the fork terminals assembled, and a reinforcing shell covering the base part; wherein the base part is provided cutout portions for gripping a circuit board the charging connector to be connected, and the reinforcing shell is provided with stopper members, corresponding to a stopper mechanism complying with the Type-C standard, formed by parts of both side faces of the reinforcing shell folded inward.

### Advantageous Effects of Invention

According to this invention, a Type-C jack connector with a charging function only can have a margin in current capacity and the manufacturing cost thereof can be lowered.

### BRIEF DESCRIPTION OF DRAWINGS

FIG. 1 is an exploded perspective view of a charging connector according to an embodiment of this invention.

FIG. 2 is an exploded perspective view of the charging connector according to the embodiment of this invention as seen from the opposite side of FIG. 1.

FIG. 3 is s a perspective view showing a state in which the charging connector of FIG. 1 is assembled.

FIG. 4 is s a perspective view showing a state in which the charging connector of FIG. 2 is assembled.

FIG. 5 is a perspective view of an existing Type-C jack connector

FIG. 6 is a view showing an arrangement state of the stopper members shown in FIG. 1 together with an arrangement state of convex portions of a plug connector.

FIG. 7 is a view showing a state in which the recess of the stopper members shown in FIG. 6 is engaged with the projection of the plug connector.

FIG. 8 is a view for explaining cutout portions provided on the stopper members shown in FIG. 1.

FIG. 9 is a view showing a state in which the charging connector is attached to a circuit board by the cutout portions shown in FIG. 8.

FIG. 10 is a cutaway perspective view showing a state of an insertion port into which a plug connector is inserted.

FIG. 11 is a view in which the cutaway part in the cutaway perspective view of FIG. 10 is replaced with a cross-sectional view.

FIG. 12 is a diagram showing a state of insulation between the grounding terminals and the power supply terminals (FIG. 12 to FIG. 14 show cross-sectional views along the center line in the lateral direction of the base part).

FIG. 13 is a diagram for comparing the state of insulation between the grounding terminals and the power supply terminals with the state in FIG. 12, showing a state in which a foreign object intrudes from the insertion port to short-circuit one of the grounding terminals and one of the power supply terminals.

FIG. 14 is a diagram showing a state when a foreign object adheres to one of the grounding terminals shown in FIG. 12.

FIG. 15 is a view showing an individual fork terminal according to another embodiment together with a cooling plate and a soldering terminal.

FIG. 16 is a view showing a soldering terminal of a grounding terminal according to another embodiment.

FIG. 17 is a view showing a soldering terminal of a power supply terminal according to another embodiment.

FIG. 18 is a cross-sectional view taken along the center line in the lateral direction of the base part and the reinforcing shell according to another embodiment.

FIG. 19 is a perspective view of a charging connector having a base part and a reinforcing shell of FIG. 18.

### DESCRIPTION OF EMBODIMENTS

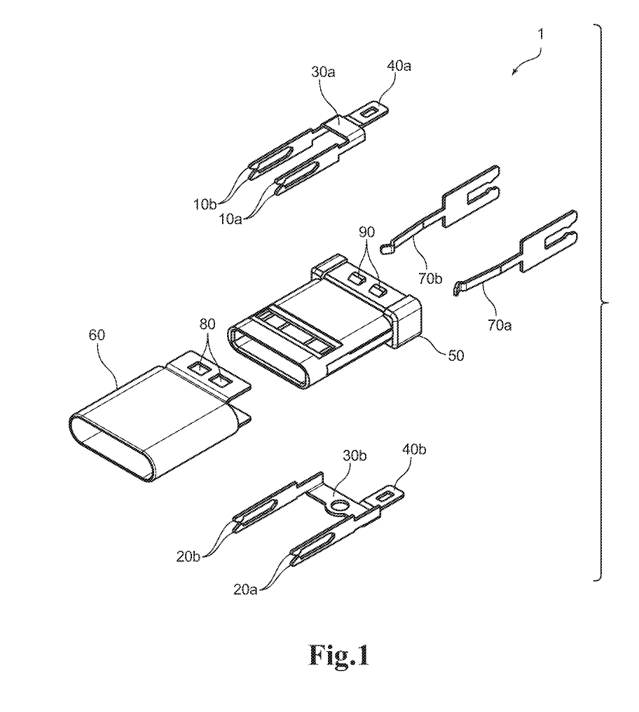

A charging connector according to an embodiment of this invention will be described with referring FIG. 1 to FIG. 10.

### BRIEF SUMMARY

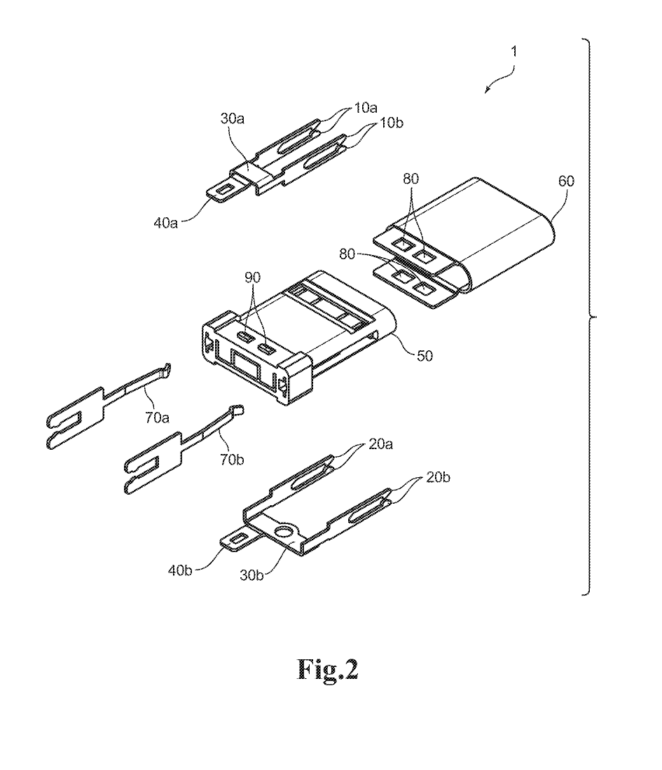

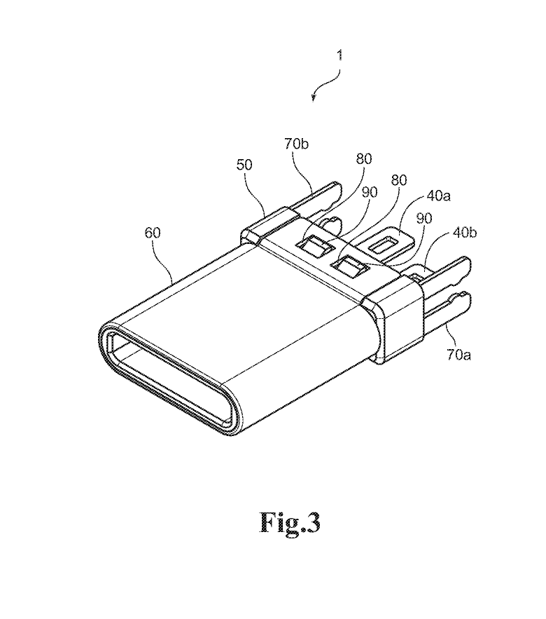

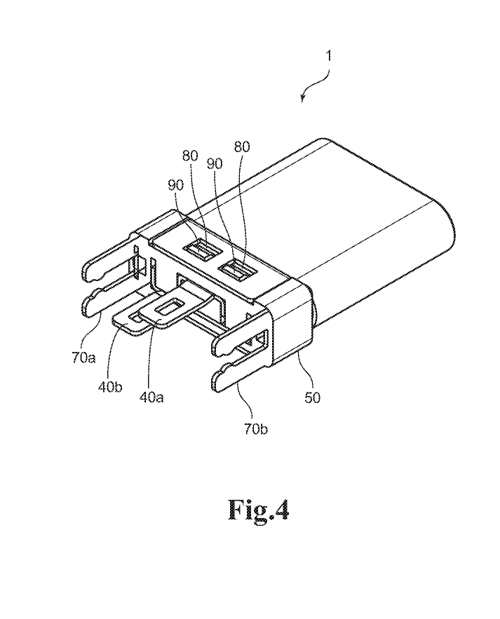

A charging connector 1 according to the embodiment of this invention comprises, as shown in FIG. 1 to FIG. 2, a pair of power supply terminals 10a and 10b for pinching power supply terminals of a Type-C plug connector (not shown in the drawings) complying with the USB connector standard from both sides and a pair of grounding terminals 20a and 20b for pinching grounding terminals of the plug connector from both sides for providing a charging function only. Each of the power supply terminals 10a, 10b and the grounding terminals 20a, 20b is configured by a fork terminal. The power supply terminals 10a, 10b and the grounding terminals 20a, 20b as well as stopper members 70a, 70b described below are inserted into a base part 50 which is covered by a reinforcing shell 60. The reinforcing shell 60 is provided holes 80 such that the reinforcing shell 60 is fixed onto the base part 50 by putting protrusions 90 provided on the base part into the holes 80 respectively. FIG. 3 and FIG. 4 show the charging connector 1 assembled.

FIG. 5 shows a perspective view of an existing Type-C jack connector. In the specifications of an existing Type-C connector, terminals for pinching plug connector side terminals from both sides are achieved by terminals 110 arranged on a supporting member 100. On the other hand, such terminals for pinching are achieved in the charging connector 1 by inserting the fork terminals into the base part 50. The power supply terminals 10a, 10b and the grounding terminals 20a, 20b are arranged symmetrically in respective pairs. According to such an arrangement, the charging connector 1 can be connected with a Type-C plug connector reversibly.

According to the charging connector 1 described above, current capacity can be made have a margin and also parts to be assembled and product process can be simplified to lower the manufacturing cost. In the following descriptions, essential members will be explained in their configurations and effects individually in detail.

[Power Supply Terminals 10a, 10b and Grounding Terminals 20a, 20b]

The power supply terminals 20a and 20b are, as shown in FIG. 1 and FIG. 2, mutually connected through a cooling plate 30a and the grounding terminals 10a and 10b are mutually connected through a cooling plate 30b. The cooling plate 30a and 30b are provided with soldering terminals 40a and 40b respectively. The soldering terminals 40a and 40b are not only to be used for connecting the charging connector 1 with conductors or electrical wires provided in a circuit board by soldering but also to contribute cooling effect as extended parts of the cooling plates 30a and 30b respectively.

Since the power supply terminals 10a, 10b and the grounding terminals 20a, 20b comprise, as described above, the cooling plate 30a and 30b and the soldering terminals 40a and 40b as extended parts of the cooling plate 30a and 30b, generation of heat can be suppressed at charging through the charging connector 1.

Each of the fork terminals forming the power supply terminals 10a, 10b and the grounding terminals 20a, 20b has larger volume than that of a Type-C standard terminal for pinching a power supply terminal or a grounding terminal of a plug connector. A metal plate forming each of the terminals 110 in the existing Type-C standard is 0.2 mm in thickness while a metal plate forming each of the power supply terminals 10a, 10b, the grounding terminals 20a, 20b, the cooling plate 30a and 30b and the soldering terminals 40a, 40b is, for example, 0.25 mm in thickness. Since the power supply terminals 10a, 10b and the grounding terminals 20a, 20b are larger in thermal capacity than the terminals 110 in the existing Type-C standard, the former can dissipate heat more than the latter.

[Stopper Members 70a and 70b as a Stopper Mechanism]

The charging connector 1 comprises, as shown in FIG. 1 to FIG. 4, stopper members 70a and 70b as a stopper mechanism specified in the Type-C standard. These stopper members 70a and 70b are formed by a metal plate thicker than a metal plate forming the reinforcing shell 60. For example, each of the stopper members 70a and 70b is formed by a metal plate 0.4 mm thick. The stopper members 70a and 70b ate inserted into sides of the base part 50 respectively. The stopper members 70a and 70b have depressed portions 71a and 71b respectively near their distal portions.

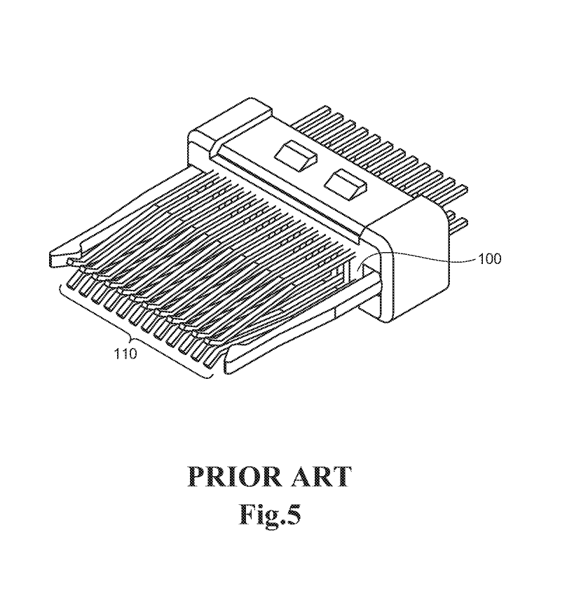

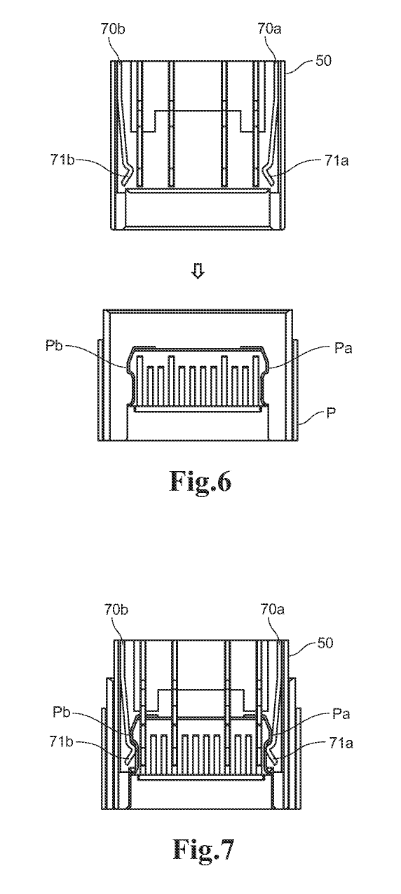

The stopper members 70a and 70b inserted into the base part 50 are, as shown in FIG. 6, curved toward the inside of the base part 50 to have constant gaps between the inner walls of the base part 50 and the depressed portions 71a and 71b respectively. As shown in FIG. 7, when a Type-C plug connector is inserted into the base part 50, convex portions Pa and Pb of a plug connector P engage with the depressed portions 71a and 71b of the stopper members 70a and 70b respectively. In this manner, the charging connector 1 and the plug connector P are joined with a predetermined coupling forth.

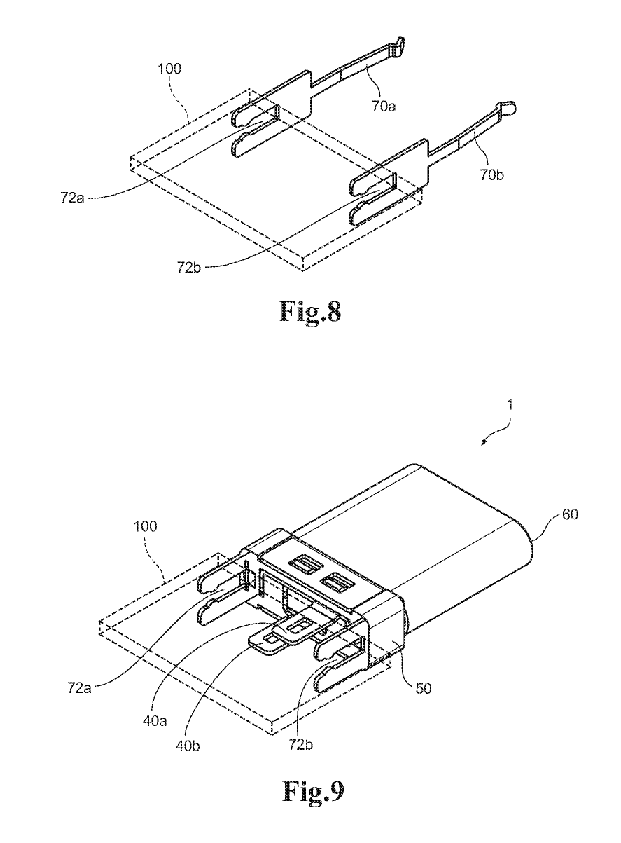

The stopper members 70a and 70b are provided, as shown in FIG. 8, with cutout portions 72a and 72b respectively at externally extending portions from the base part 50 for gripping the circuit board 100 to which the charging connector 1 is connected. In this manner, as shown in FIG. 9, the charging connector 1 can be attached to the circuit board 100 by means of the cutout portions 72a and 72. In this situation, the soldering terminals 40a is located at the upper side or power supply side of the circuit board 100 and the soldering terminal 40b is located at the lower side or grounding side of the circuit board 100.

As described above, the stopper members 70a and 70 b realize not only a stopper mechanism specified in the Type-C standard but also a mechanism for connecting the charging connector to the circuit board simultaneously. It can make the number of parts for assembling the charging connector and product man-hours be reduced to lower the manufacturing cost.

[Insertion Port 51]

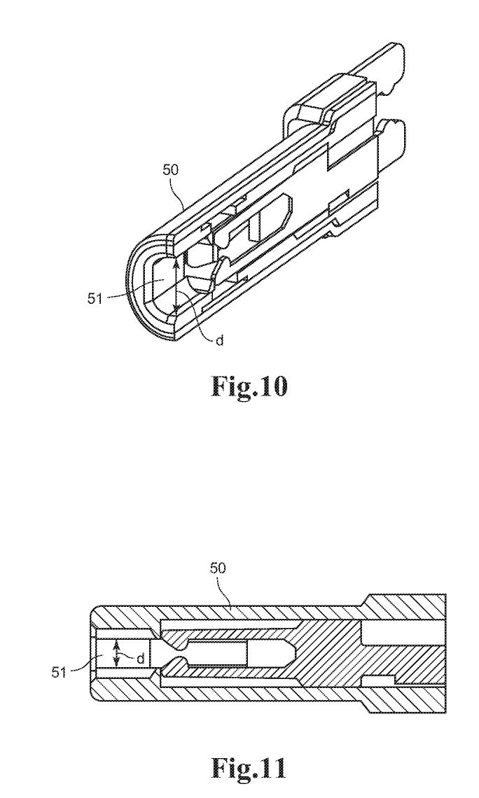

The base part 50 is provided, as shown in FIG. 10 and FIG. 11, with a insertion port 51 for a plug connector specified in the Type-C standard. The opening area of the insertion port 51 is smaller than that specified in the Type-C standard. Specifically, the width in the shorter direction of the insertion port 51 is made approximately 30% narrower than that of the existing Type-C standard. It can make a gap between a plug connector inserted into the charging connector and the charging connector 1 to prevent a foreign object such as dirt or the like from intruding.

[Insulation Members 52a, 52b and 53 for Grounding Terminals 20a, 20b and Power Supply Terminals 10a, 10b]

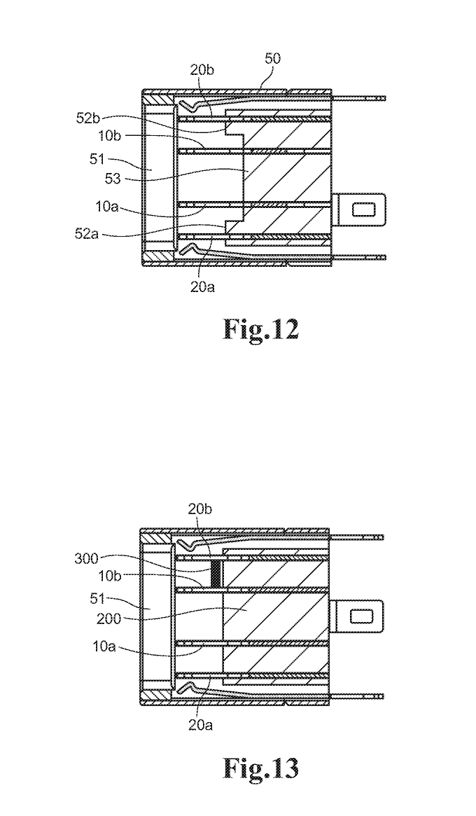

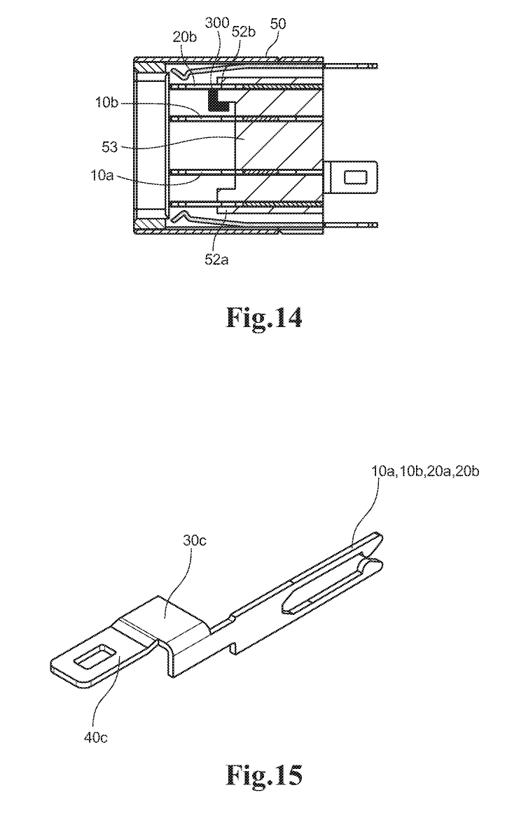

The base part 50 comprises an insulation member 53 covering the power supply terminals 10a and 10b partly, and insulation members 52a, 52b covering the grounding terminals 20a and 20b partly. The grounding terminals 20a and 20b are, as shown in FIG. 12, not covered fully by the insulation members 52a and 52b of the base part 50. The power supply terminals 20a and 20b are, as shown in FIG. 12, not covered fully by the insulation member 53 of the base part 50. The insulator member 53 for the power supply terminals 10a and 10b is recessed from the insulation members 52a and 52b for the grounding terminals 20a and 20b. That is, the length of parts of the grounding terminals 20a and 20b not covered by the insulator members 52a and 52b in the base part 50 is different from the length of parts of the power supply terminals 10a and 10b not covered by the insulator member 53 in the base part 50.

In a reference example shown in FIG. 13, the length of the parts of the grounding terminals 20a and 20b not covered by the insulator members 52a and 52b is same with that of the parts of the power supply terminals 10a and 10b not covered by the insulator member 53. In such a case, when extraneous material 300 enters from the insertion port 51 into the inside, it may cause a short circuit between the grounding terminal 20b and the power supply terminal 10b. On the other hand, by differentiating the length of the parts of the grounding terminals 20a and 20b not covered by the insulator members 52a and 52b from that of the parts of the power supply terminals 10a and 10b not covered by the insulator member 53, the extraneous material 300 may not cause a short circuit between the grounding terminal 20b and the power supply terminal 10b. Especially in the Type-C standard, since relatively large current as 5 mA (20V, 100 W) in maximum may flow, it is useful to arrange the power supply terminals 10a, 10b and the grounding terminals 20a, 20b to be prevented from shorting by the extraneous material 300 entering.

As described above, by differentiating the length of the parts of the grounding terminals 20a and 20b not covered by the insulator members 52a and 52b from that of the parts of the power supply terminals 10a and 10b not covered by the insulator member 53, it can be prevent the power supply terminals 10a, 10b and the grounding terminals 20a, 20b from shorting by the extraneous material 300 entering or the like.

### Other Embodiments

The above mentioned embodiment may be arranged variously without deviating from the scope of this invention.

For example, each of or any of the power supply terminals 10a, 10b or the grounding terminals 20a, 200b may be, as shown in FIG. 15, configured individually. Each of the individually formed power supply terminals 10a, 10b or grounding terminals 20a, 200b have a cooling plate 30c and a soldering terminals 40c.

By forming the power supply terminals 10a, 10b and the grounding terminals 20a, 20b individually as described above, for example, one kind of fork members may be used for configuring the power supply terminals 10a, 10b and the grounding terminals 20a, 20b to reduce the number of kinds of parts.

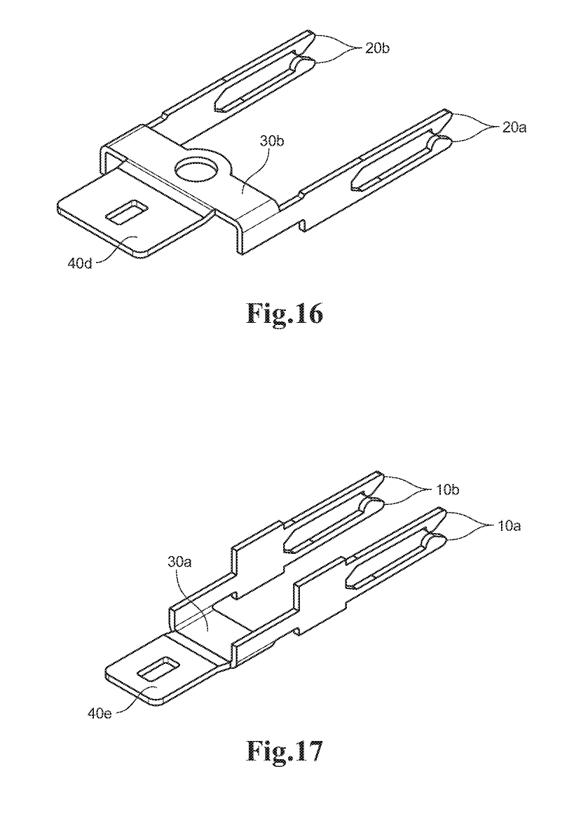

As shown in FIG. 16, the soldering terminal 40d of the ground circuit terminals 20a, 20b is wider than the soldering terminal 40b shown in FIG. 1. Similarly, as shown in FIG. 17, the soldering terminal 40e of the power supply terminals 10a, 10b is wider than the soldering terminal 40a shown in FIG. 1. In this manner, the width of the soldering terminal may be variously changed. The soldering terminal 40d of an individual fork terminal may also be changed in width variously. A hole provided at each of the soldering terminals 40a, 40b, 40c, 40d and 40e for making soldering easy may not be provided

By appropriately changing the width of the soldering terminal and the presence or absence of the hole, the charging connector according to this invention can comply with various design standards.

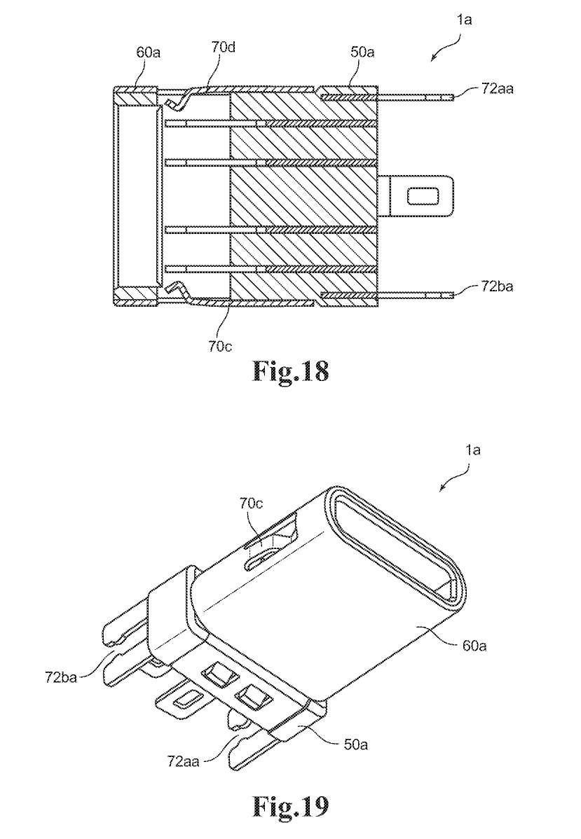

As shown in FIG. 18 and FIG. 19, the base part 50a may be provided with cutout portions 72aa and 72ba for gripping the circuit board 100 to which the charging connector 1a is attached and the reinforcing shell 60a may comprise stopper members 70c and 70, corresponding to a stopper mechanism complying with the Type-C standard, formed by parts of both side faces of the reinforcing shell 60a folded inward.

As a result, the stopper members 70a and 70b cannot be provided and members of the cutout portions 72aa and 72ba can be simplified so that the manufacturing cost can be reduced.

In the embodiment described above, only the power supply circuit terminals 10a, 10b and the ground circuit terminals 20a, 20b are shown. However, in addition to these, it is possible to additionally provide terminals such as signal terminals. For example, in order to make the charging connector 1 chargeable even to a device having a connector of a standard other than Type-C (for example, Type-A, etc.), corresponding signal terminals may be added in accordance with the standard to enable to connect with a connector other than Type-C. According to this, the charging connector 1 can be made compatible with connectors of various standards.

### Effects According to the Embodiments of this Invention

In this manner, the charging connector 1 can have a margin in the current capacity, the number of parts and the manufacturing process can be simplified, and the manufacturing cost can be reduced.

More specifically, in a conventional type-C connector, since the circuits of the connector pass through the circuit board, conducting cross-sectional areas of the circuits are small, surface areas for radiating heat are small, and heat capacities of the conductors are small. On the other hand, in the charging connector 1, fork terminals having larger volume than that of Type-C standard terminals are used for the power supply terminals 10a, 10b and the ground circuit terminals 20a, 20b so that the current capacity and heat capacity increase. For this reason, the amount of heat generated by the power supply terminals 10a, 10b and the grounding terminals 20a, 20b at the time of energization is small and the heat radiation amount is increased. Therefore, the temperature rise of the power supply terminals 10a, 10b and the grounding terminals 20a, 20b at the time of energization can be suppressed lower than in the prior art.

The soldering terminals 40a and 40b may be soldered not only to the circuit board but also to electric wires directly. In a conventional Type-C connector, it is impossible to directly solder terminals to electric wires directly. Since the charging connector is to have a charging function only, it is advantageous to solder the soldering terminals 40a and 40b directly to respective electric wires having large current capacities.

Further, for manufacturing the charging connector 1, a highly precise process for arranging a small terminal member on a circuit board is not required, and the stopper mechanism is also realized by a member having a simple shape. Therefore, the charging connector 1 can be manufactured at low cost.

1.A charging connector comprising: a pair of power supply terminals for pinching power supply terminals of a Type-C plug connector complying with the USB connector standard from both sides, and a pair of grounding terminals and for pinching grounding terminals of the plug connector from both sides; wherein
the power supply terminals and the grounding terminals are configured by fork terminals.

2. The charging connector according to claim 1, wherein the fork terminals are provided with cooling plates.

3. The charging connector according to claim 1, wherein a pair of the fork terminals are connected by a cooling plate.

4. The charging connector according to claim 1, wherein each of the fork terminals has larger volume than that of a Type-C standard terminal for pinching a power supply terminal or a grounding terminal of a plug connector from both side.

5. The charging connector according to claim 2, wherein a soldering terminal is provided on the cooling plate at opposite side of the fork terminal.

6. The charging connector according to claim 1, further comprising a base part the fork terminals assembled, and a reinforcing shell covering the base part; wherein stopper members complying with a stopper mechanism specified in the Type-C standard are assembled on both sides of the fork terminals in the base part.

7. The charging connector according to claim 6, the stopper members are provided with cutout portions respectively at externally extending portions from the base part for gripping a circuit board the charging connector to be connected.

8. The charging connector according to claim 6, wherein the base part is provided with a insertion port for a plug connector specified in the Type-C standard, the opening area of the insertion port being smaller than that specified in the Type-C standard.

9. The charging connector according to claim 6, wherein the base part comprises insulation members covering the power supply terminals and the grounding terminals partly, the length of parts of the grounding terminals not covered by the insulator members being different from the length of parts of the power supply terminals not covered by the insulator members.

10. The charging connector according to claim 1, further comprising a base part the fork terminals assembled, and a reinforcing shell covering the base part; wherein the base part is provided cutout portions for gripping a circuit board the charging connector to be connected, and the reinforcing shell is provided with stopper members, corresponding to a stopper mechanism complying with the Type-C standard, formed by parts of both side faces of the reinforcing shell folded inward.
